(19) United States
(12) Patent Application Publication
(10) Pub. No.: US 2013/0257673 A1
(43) Pub. Date: Oct. 3, 2013

(54) Mobile Communication Coverage Distribution System in Corridor and Coupled Radiation Unit

(71) Applicants: Qinyuan Wang, Gaungzhou City (CN); Shanqiu Sun, Gaungzhou City (CN); Keyong Jiang, Gaungzhou City (CN); Peitao Liu, Gaungzhou City (CN); Junxiang Li, Gaungzhou City (CN); Binlong Bu, Guangzhou City (CN)

(72) Inventors: Qinyuan Wang, Gaungzhou City (CN); Shanqiu Sun, Gaungzhou City (CN); Keyong Jiang, Gaungzhou City (CN); Peitao Liu, Gaungzhou City (CN); Junxiang Li, Gaungzhou City (CN); Binlong Bu, Guangzhou City (CN)

(73) Assignee: Comba Telecom System (China) Ltd, Guangdong Province (CN)

(21) Appl. No.: 13/991,623

(22) PCT Filed: Oct. 28, 2011
(86) PCT No.: PCT/CN11/81470

§ 371 Date: Jun. 12, 2013

(30) Foreign Application Priority Data
Dec. 8, 2010 (CN) 201010578679.4

(51) Int. Cl. H01Q 21/00; H01Q 1/50

(52) U.S. Cl. CPC H01Q 21/0006; H01Q 1/50
USPC 343/852; 343/905

(57) ABSTRACT

A mobile communication coverage distribution system in corridor is used for mobile communication signal coverage in corridor environment. The system includes a radio frequency (RF) cable arranged along longitudinal direction of the corridor and intended for signal transmission and having a plurality of spaced access nodes; a signal source for transmitting signal to from the RF cable or receiving signal to from the RF cable; a number of coupled radiation units corresponding to each access node and used to realize signal coverage in a limited range near the access node, said signal being transmitted across the RF cable. The mobile communication coverage distribution system in corridor according to the invention has simple structure, low cost, is convenient in construction and has reliable performance.

### FIELD OF THE INVENTION

The present invention relates to mobile communication antenna coverage technology and more particularly, relates to a mobile communication coverage distribution system in corridor and a coupled radiation unit applied thereto.

### BACKGROUND OF THE INVENTION

With high speed development of mobile communication technology and national economy, people have higher and higher requirement for coverage quality of mobile communication. Mobile communication operators have tried their best to provide excellent mobile communication services for people anytime and anywhere. To this end, at one hand, the mobile communication operators have given their strength on optimization of base station network and at the other hand; they provide signal coverage in specific environments where coverage blind spot occurs. However, in actual environment, various corridor environments are trouble regions to be covered by network. These corridor environments may include tunnels, subway, lift shaft, narrow passageway in urban village and room which can be divided into a corridor. Currently, corridor is covered by following manners:

1. Tunnels and Subway

As shown in FIG. 1, they are generally covered by leaky cables of which technology is relatively mature and it can meet most environment coverage. However, with high speed development of city metro, leaky cable coverage has three significant disadvantages as follows:

(1) For a train with high speed, attenuation of train body is greater than a traditional one and the attenuation is about 24 dB. However, leaky cable has weak radiation level, thus leading to bad coverage effect and in some extreme instances, failing to realize network coverage.

Presently, China Railway High speed trains have been developed in many cities of China. It has been testified by experiments that robust train body causes attenuation of about 24 dB which is about 10 dB higher than a traditional one. In high speed train running tunnel environment, conventional leaky cable has poor coverage effect and in some cases, it may fail to meet network coverage.

(2) Leaky cable in particular abroad imported leaky cable is very expensive, thus resulting networking cost of the operator.

(3) Installation of leaky cable is difficulty. Arrangement of leaky cable in tunnel requires large and cumbersome vehicle to transport the leaky cable into the tunnel and it can't be finished by human labor. Meanwhile, in order not to affect the radiation performance of the leaky cable, the leaky cable should be installed so as to be distanced sufficiently from the tunnel wall, hence requiring numerous holding brackets and this further increasing installation difficulty and cost.

2. Lift Shaft and Narrow Passageway in Urban Village

Generally, there are two kinds of coverage solutions.

One solution is to employ leaky cable, suffering from disadvantages (2) and (3) as described above.

The other solution is to employ directional antenna coverage for example Yagi antenna or Log Periodic Antenna. The antenna radiation pattern features single direction radiation. Due to path attenuation in coverage region, the power level difference between near radiation region and far radiation region is almost up to tens of dB, thus causing uneven radiation level. At the same time, due to influence of the walls, the main-lobe radiation will biased away from the corridor direction and accordingly, the coverage distance is shortened. In addition, interference to other directions may be resulted. Furthermore, a conventional directional antenna is used to cover urban village. As a great number of independent and non-integrated splitters and couplers are used to balance and distribute power, serious problems such as “back line” during construction process. This not only increases loss of feed line but also increases burden on routing.

### SUMMARY OF THE INVENTION

A main object of the invention is to provide a more comprehensive and efficient mobile communication coverage solution for various narrow corridors and therefore, a mobile communication coverage distribution system in corridor is proposed which improves coverage effect, reduces construction difficulty and cost of corridor coverage engineering.

Another object of the invention is to provide a coupled radiation unit adaptive to the aforementioned system.

To realize the above objects, the following technical solution is provided.

The mobile communication coverage distribution system in corridor according to the invention is used for mobile communication signal coverage in corridor environment. The system includes: a radio frequency (RF) cable arranged along longitudinal direction of the corridor and intended for signal transmission and having a plurality of spaced access nodes; a T/R model for transmitting signal to the RF cable or receiving signal from the RF cable; a number of coupled radiation unit corresponding to each access node and used to realize signal coverage in a limited range near the access node, said signal being transmitted across the RF cable.

The coupled radiation unit includes: a bidirectional radiation antenna for realizing bidirectional signal coverage in space; and a directional coupler for signal coupling between the bidirectional radiation antenna and RF cable. The bidirectional radiation antenna and directional coupler are integrated onto a metal base plate.

The coupled radiation unit further includes a double frequency multiplexer for multiplexing signals of two frequency bands. The bidirectional radiation antenna includes two radiation elements of different frequency bands. When signals are uplinked, signals from space are received by two radiation elements of the bidirectional radiation antenna, and then are coupled by the coupler. Next, the signals are multiplexed by the multiplexer and finally are transmitted to the RF cable. When signals are down-linked, the signals from the RF cable are split by the multiplexer and then are coupled to the two radiation elements of the bidirectional antenna and finally, they are transmitted to space through the two radiation elements.

The coupler is formed on the metal base plate. One side of the coupler is provided with the double frequency multiplexer formed on the metal base plate, while the other side thereof is provided with an erected dielectric substrate. The bidirectional radiation antenna is printed on the dielectric substrate.

The coupled radiation unit has a suspension member suspended on a periphery wall of the corridor.

Preferably, the plurality of access nodes is distributed equidistantly. The coupling coefficient of the directional coupler is proportional to the distance of the directional coupler from the signal source. The signal source may be any one of repeater, macro base station, micro base station and radio remote unit. The two frequency bands range from 790-960 MHz and 1710-2700 MHz respectively. The number of the signal sources is two and two signal sources are arranged on two ends of the RF cable respectively for bidirectional transmission of signals.

Compared with conventional technology, the present invention has the following advantages. The design of the invention is simple. For example, the RF cable is combined with a standalone coupled radiation unit, thus replacing conventional leaky cable, significantly reducing cost, and being able to get great commercial success. In addition, as weight of the RF cable is much less than leaky cable and the RF cable can be installed piece by piece, construction process is simplified. Moreover, coverage ability of the system becomes more even and better by reasonably designing distance between the access nodes. Furthermore, the integrated coupled radiation unit can be formed together with walls and therefore, low wind resistance is generated.

### BRIEF DESCRIPTION OF THE DRAWINGS

FIG. 1 shows schematically corridor coverage realized by conventional leaky cable;

FIG. 2 shows schematically a mobile communication coverage distribution system in corridor adapted to a coupled radiation unit of single frequency according to the invention;

FIG. 3 shows schematically a mobile communication coverage distribution system in corridor adapted to a coupled radiation unit of double frequency according to the invention;

FIG. 4 illustrates a practical application of the mobile communication coverage distribution system in corridor of the invention into a 500 meters long road tunnel;

FIG. 5 illustrates a practical application of the mobile communication coverage distribution system in corridor of the invention into a 1000 meters long road tunnel;

FIG. 6 illustrates a practical application of the mobile communication coverage distribution system in corridor of the invention into a 500 meters long high speed railway tunnel; and

FIG. 7 illustrates a practical application of the mobile communication coverage distribution system in corridor of the invention into a 1000 meters long high speed railway tunnel.

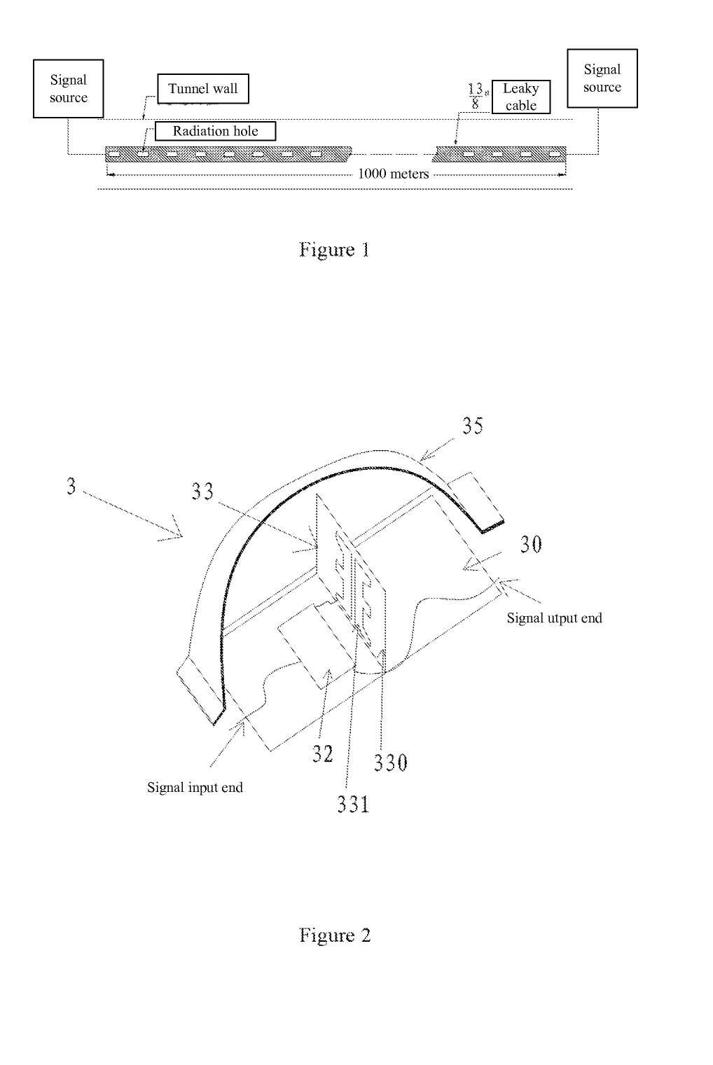

### DETAILED DESCRIPTION OF THE INVENTION

The present invention is further described in conjunction with accompanied drawings and embodiments.

With reference to FIGS. 4-7, a mobile communication coverage distribution system in corridor of the invention includes a signal source 2, a radio frequency (RF) cable 4 and a number of integrated coupled radiation unit 3.

The signal source 2 may be any kind of replying devices such as repeater, macro base station, micro base station or radio remote unit (RRU) for transmitting to the RF cable 4 downlink signals coming from a mobile communication system base station or receiving from the RF cable 4 uplink signals coming from a mobile station and then transmitting the signals to the base station.

The RF cable 4 is divided into multiple segments. In present embodiment, it is divided into multiple segments with equidistance. For example, each segment may be 250 meters long and an access node P is defined between two segments for transmitting uplink or downlink signals.

The coupled radiation unit 3 may be designed to adapt either to single frequency band or to double frequency band.

As shown in FIG. 2, the coupled radiation unit 3 of single frequency includes a metal base plate 30 on which a directional coupler 32 is formed, a suspension member 35 and a dielectric substrate 330 on which a bidirectional radiation antenna 33 is formed. The suspension member 35 is fixedly connected with the metal base plate 30 such that the entire coupled radiation unit 3 can be suspended on the peripheral walls of the corridor through the suspension member 35. The directional coupler 32 is directly formed on the metal base plate 30. One side of the metal base plate 30 on which the directional coupler 32 is disposed is provided with the dielectric substrate 330 having the bidirectional radiation antenna 33. Downlink signals are coupled with the radiation element 331 of the bidirectional radiation antenna 33 by the directional coupler 32. Then, downlink signals are transmitted to space by the bidirectional radiation antenna 33. Or, uplink signals are received by the radiation element 331 of the bidirectional radiation antenna 33 and are coupled into an uplink system by the coupler 32, thus transferring uplink of the signals.

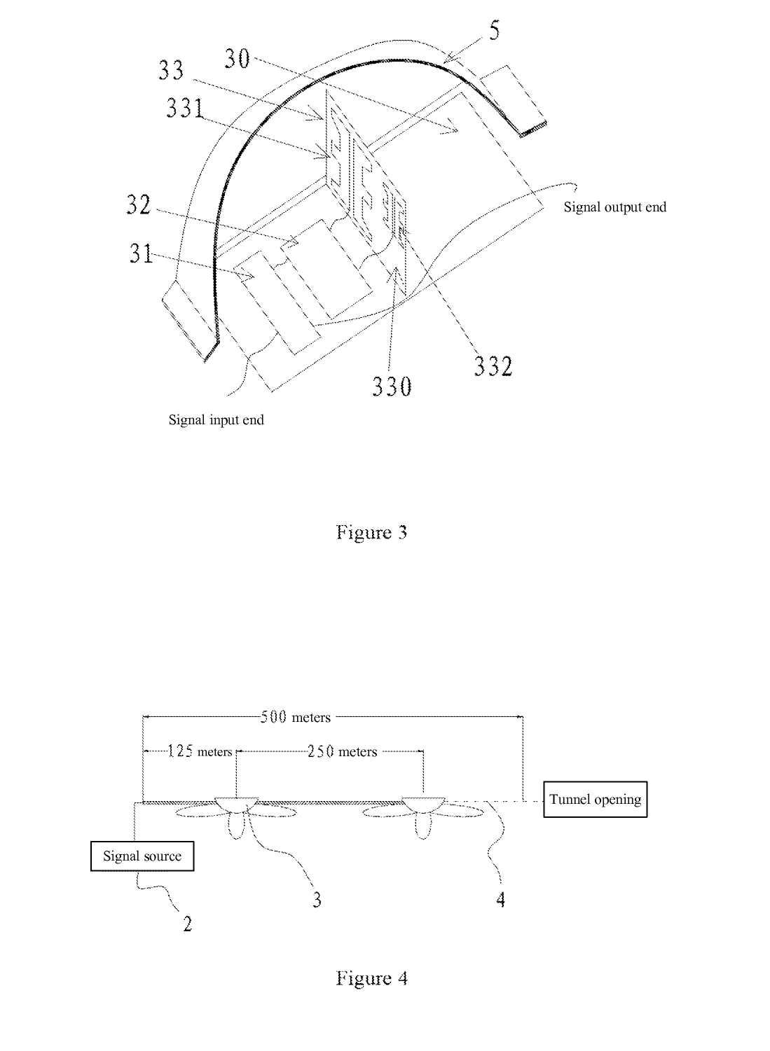

As shown in FIG. 3, a coupled radiation unit 3 of double frequency is different from the one described above and may be used in double frequency application. The difference of unit 3 as shown in FIG. 3 from unit 3 (shown in FIG. 2) lines in a double frequency multiplexer 31 is disposed on the metal base plate 30 at one side relative to the dielectric substrate 330 and where the directional coupler 32 is located. The bidirectional radiation antenna 33 on the dielectric substrate 330 includes two radiation elements 331 and 332 corresponding respectively to low frequency signals and high frequency signals. When signals are down-linked, the signals are split by the multiplexer 31 and then are coupled to the two radiation elements 331 and 332 of the bidirectional radiation antenna 33 by the directional coupler 32 and finally, they are transmitted to space through the two radiation elements 331 and 332. Or, uplink signals are received by the two radiation elements 331 and 332 and are coupled by the directional coupler 32 and then multiplexed by the double frequency multiplexer 31. Finally, the signals are fed into an uplink system so as to transfer uplink of the signals. The double frequency means two frequency bands ranging from about 790-960 MHz and 1710-2700 MHz respectively.

Reference is made to FIGS. 2, 4 and 7. For a single frequency band application, downlink signals coming from the base station of the mobile communication system are received by the signal source 2 and then are transmitted from the signal source 2 alternatively through pieces of RF cables and multiple coupled radiation units 3 and along the entire RF cable 4. At each access node P (not shown), the downlink signals are coupled to the bidirectional radiation antenna 33 by the directional coupler 32 of the coupled radiation unit 3 and then are transmitted to a limited space environment. By this manner, the mobile station in the corridor is able to receive downlink signals.

By the same token, uplink signals are transmitted from the mobile station inside the corridor and are received by the bidirectional radiation antenna 33. Next, the signals are coupled into the RF cable 4 by the directional coupler 32. After that, the signals are further up-linked to the signal source 2 through pieces of RF cable 4. Finally, the signals are transferred to the base station of the mobile communication system by the signal source 2 such that the signals will be further processed.

Referring to FIGS. 3-7, for a double frequency band application, signals should be split or multiplexed by the double frequency multiplexer 31 respectively regardless of downlink or uplink of the signals and as such, the directional coupler 32 is not directly connected to the RF cable 4. Rather, the connection should be realized by the double frequency multiplexer 31.

Considering that attenuation will occur when the signals directly pass through the entire piece of RF cable 4, the coupling coefficient of each directional coupler 32 is adjusted in order to compensate attenuation. Specifically, during construction process, based on attenuation characteristics of the RF cable 4 and distance between the access nodes P, the coupling coefficient of the directional coupler 32 is measured and set up. The detailed measure method is well known in the art.

The RF cable 4 of the invention is preferably a coaxial cable which is less expensive than leaky cable.

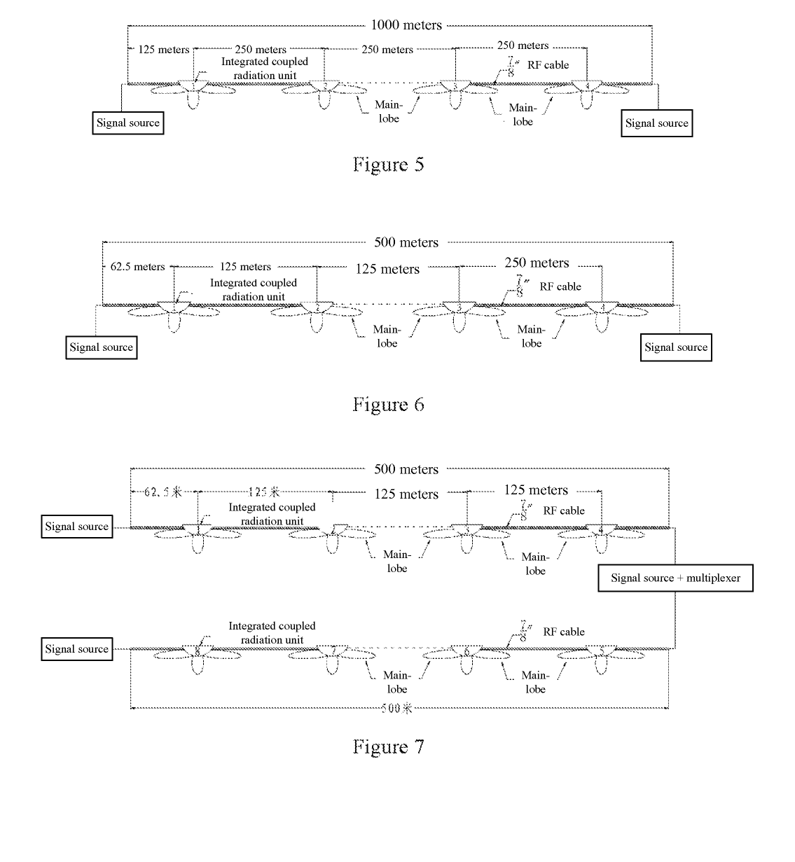

Referring to FIGS. 4-7, considering effective transmission distance of the RF cable 4, in a normal road tunnel, the entire length of the RF cable 4 as used in the mobile communication coverage distribution system in corridor of the invention is preferably not greater than 500 meters (FIG. 4). In length of 500 meters, the plurality of access nodes P may be arranged such that they are distanced 125 or 250 meters from each other. In case that the length is within 1000 meters as shown in FIG. 5, another end of the entire RF cable 4 may be provided with a signal source 2 for improving signal transmission quality of the RF cable 4.

To adapt to influence of high speed trains on signals, two ends of the RF cable 4 may be equipped with a signal source (FIG. 6) in case that the length of the high speed tunnel is over 500 meters long. For high speed train tunnel length of 1000 meters and more, two signal sources 2 may be arranged in the tunnel every 500 meters long, and two adjacent signal sources are multiplexed by the multiplexer (See FIG. 7). Various modifications made based on above principles fall within the scope of the invention.

Summarily, the mobile communication coverage distribution system in corridor according to the invention has simple structure, low cost, is convenient in construction and has reliable performance.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A mobile communication coverage distribution system in corridor for mobile communication signal coverage in corridor environment, comprising:
a radio frequency cable arranged along a longitudinal direction of the corridor and intended for signal transmission and having a plurality of spaced access nodes;
a signal source for transmitting signal to the radio frequency cable or receiving signal from the radio frequency cable;
a number of coupled radiation units corresponding to each access node and used to realize signal coverage in a limited range near the access node, said signal being transmitted across the radio frequency cable.

2. The mobile communication coverage distribution system in corridor according to claim 1, wherein the coupled radiation unit comprises:
a bidirectional radiation antenna for realizing bidirectional signal coverage in space and insensitive to reflection of walls; and
a directional coupler for signal coupling between the bidirectional radiation antenna and radio frequency cable;
the bidirectional radiation antenna and directional coupler are integrated onto a metal base plate.

3. The mobile communication coverage distribution system in corridor according to claim 2, wherein the coupled radiation unit further comprises a double frequency multiplexer for multiplexing signals of two frequency bands; the bidirectional radiation antenna includes two radiation elements of different frequency bands; when signals are uplinked, signals from space are received by two radiation elements of the bidirectional radiation antenna, and then are coupled by the coupler, and next, the signals are multiplexed by the multiplexer and finally are transmitted to the radio frequency cable; when signals are down-linked, the signals from the radio frequency cable are split by the multiplexer and then are coupled to the two radiation elements of the bidirectional antenna and finally, they are transmitted to space through the two radiation elements.

4. The mobile communication coverage distribution system in corridor according to claim 3, wherein the coupler is formed on the metal base plate; one side of the coupler is provided with the double frequency multiplexer formed on the metal base plate, while the other side thereof is provided with an erected dielectric substrate; and the bidirectional radiation antenna is printed on the dielectric substrate.

5. The mobile communication coverage distribution system in corridor according to claim 1, wherein the coupled radiation unit has a suspension member suspended on a peripheral wall of the corridor.

6. The mobile communication coverage distribution system in corridor according to claim 1, wherein the plurality of access nodes is distributed equidistantly.

7. The mobile communication coverage distribution system in corridor according to claim 1, wherein the signal source is any one of a repeater, macro base station, micro base station and radio remote unit.

8. The mobile communication coverage distribution system in corridor according to claim 3, wherein the two frequency bands range from about 790-960 MHz and 1710-2700 MHz respectively.

9. The mobile communication coverage distribution system in corridor according to claim 1, wherein the number of the signal sources is two and the two signal sources are arranged on two ends of the radio frequency cable respectively for bidirectional transmission of signals.

10. A coupled radiation unit, comprising:
a bidirectional radiation antenna for realizing bidirectional signal coverage in space and insensitive to reflection of walls; and
a directional coupler for signal coupling between the bidirectional radiation antenna and radio frequency cable;
the bidirectional radiation antenna and directional coupler are integrated onto a metal base plate.

11. The mobile communication coverage distribution system in corridor according to claim 2, wherein the coupled radiation unit has a suspension member suspended on a peripheral wall of the corridor.

12. The mobile communication coverage distribution system in corridor according to claim 2, wherein the plurality of access nodes is distributed equidistantly.

13. The mobile communication coverage distribution system in corridor according to claim 2, wherein the signal source is any one of a repeater, macro base station, micro base station and radio remote unit.

14. The mobile communication coverage distribution system in corridor according to claim 2, wherein the number of the signal sources is two and the two signal sources are arranged on two ends of the radio frequency cable respectively for bidirectional transmission of signals.

15. The mobile communication coverage distribution system in corridor according to claim 3, wherein the coupled radiation unit has a suspension member suspended on a peripheral wall of the corridor.

16. The mobile communication coverage distribution system in corridor according to claim 3, wherein the plurality of access nodes is distributed equidistantly.

17. The mobile communication coverage distribution system in corridor according to claim 3, wherein the signal source is any one of a repeater, macro base station, micro base station and radio remote unit.

18. The mobile communication coverage distribution system in corridor according to claim 3, wherein the number of the signal sources is two and the two signal sources are arranged on two ends of the radio frequency cable respectively for bidirectional transmission of signals.

19. The mobile communication coverage distribution system in corridor according to claim 4, wherein the coupled radiation unit has a suspension member suspended on a peripheral wall of the corridor.

20. The mobile communication coverage distribution system in corridor according to claim 4, wherein the plurality of access nodes is distributed equidistantly.
